(19) United States
(12) Patent Application Publication
(10) Pub. No.: US 2018/0190252 A1
(43) Pub. Date: Jul. 5, 2018

(54) METHOD FOR APPLYING SENSORS ON A STRINGED INSTRUMENT

(71) Applicant: MODERN ANCIENT INSTRUMENTS NETWORKED AB, 121 54 Johanneshov (SE)

(72) Inventors: Michele Benincaso, Johanneshov (SE); Agostino De Angelis, Lucera (IT); Carlo Fischione, Stockholm (SE); Luca Turchet, London (GB); Stefano Zambon, (US)

(21) Appl. No.: 15/736,377

(22) PCT Filed: May 29, 2016
(86) PCT No.: PCT/SE2016/050493

§ 371 Date: Dec. 14, 2017

(30) Foreign Application Priority Data
Jun. 22, 2015 (SE) 1530096-5

(51) Int. Cl. G10H 1/34; G10D 3/06

(52) U.S. Cl. CPC G10H 1/342; G10D 1/08; G10H 2220/301; G10D 3/06

(57) ABSTRACT

The invention describes the design and the technique for creating the ideal bed and for positioning sensors to the neck of a stringed instrument, such as a guitar. The problem solved addresses the need of the performer to easily identify, activate or deactivate one or more sensors while, at the same time, playing the instrument and without, for instance, unnatural or uncomfortable torsions of the hand or unwanted pauses. The solution provided consists on an ad-hoc chamfered flat surface on the back part of the guitar's neck; such flat surface is the ideal bed where sensors can be located and accessed.

### TECHNICAL FIELD

The present disclosure relates to stringed instruments, and specifically to necks for stringed instruments. Such instruments being augmented string instruments thanks to the use of sensors.

### BACKGROUND

The possibility to attach sensors to musical instruments has extended the possibilities of use of the instruments themselves; these instruments are today called in different ways, such as augmented or hyper-instruments or other names (Tod and Chung 1989). Examples of digital instruments are various such as one explained in US 20110088535 A1.

Musicians today can enhance their musical expression and create a variety of effects and/or control a variety of functions thanks to the sensors applied to various parts of such instruments.

An important aspect of such augmented instruments refers to the way sensors are applied to the instruments in order to avoid unnatural positioning of the body of the performer (e.g., hands, fingers, arms, feet), which might limit the style and ease of the execution. For instance, reaching a sensor even for just few seconds requires the player to keep his/her hand out of the strings, thus creating an incidental pausing effect on the performance.

Several types of augmented stringed instruments such as guitars have been built. U.S. Pat. No. 8,093,486 B2 describes an electric guitar involving at least one touch sensor without specifying their location. Both U.S. Pat. No. 7,718,886 B1 and U.S. Pat. No. 7,247,789 B2 teach different sensor assembly techniques. U.S. Pat. No. 6,570,078 B2 defines tactile sensors where sensors are displaced in different areas of the instrument. However, prior art doesn't cover teachings in reference to the ideal position of such sensors inside the instrument or on the surface of the instrument; such ideal position is relevant because it will provide the least possible hurdle in activating the sensors while, at the same time, being involved with the act of playing the instrument

More specifically, a common problem of augmented instruments, such as guitars, is to allow the musician to: a) access, mainly through the sense of touch, where the sensors are located and b) interact with the sensor with ease (i.e. pressing, holding the sensor).

Prior art shows prototypes of augmented stringed instruments where the sensors are located on the neck of the instrument. This location finds a particularly effective bed for the sensors because:
a) the back side of the neck is the area of the guitar which is continuously touched by the musician's thumb, therefore solves the problem of ease accessibility;
b) reaching such area allows one to keep playing while, at the same time, interacting with the sensor, therefore allowing to use the sensor and minimizing the disturbance to the act of playing.

Another more specific problem, such problem related to the choice of positioning the sensor on the neck of the guitar, is that such area proves to be challenging because:
c) it has normally a half round shape, which reduces the effectiveness of pressing correctly a sensors, compared to the act of pressing a sensor on flat surface;
d) the fast movements of player's thumb during the act of playing limit the control of the sensor by the thumb, especially because the player cannot easily recognize by fingertip pressure the exact location of the sensors

It is in reference to such problems c) and problems d) that the present invention provides a solution; such solution being a purposeful designed back of the neck and such solution including a technique to apply the sensor to the back of the neck of an augmented string instrument, such as a guitar.

### DESCRIPTION OF THE DRAWINGS

FIG. 1.A describes a view of the front part of a stringed instrument such as a guitar.

FIG. 1.B describes a view of the rear part of the instrument, with sensors applied on the guitar's neck in the location specified by the invention.

FIG. 2 illustrates a tridimensional section of the neck of the instrument

FIG. 3.A illustrates a bidimensional section of the neck of the instrument.

FIG. 3.B illustrates a bidimensional section of the neck of the instrument with the grooved flat surface object of the invention.

### DETAILED DESCRIPTION

The present invention discloses a particular functional design of the neck of an augmented stringed instrument, such as a guitar, and a particular technique to apply sensors to such augmented stringed instrument. Such found design is purposefully shaped and creates an ideal bed for one or more sensors in order to facilitate the best possible accessibility to the sensors and their best usability.

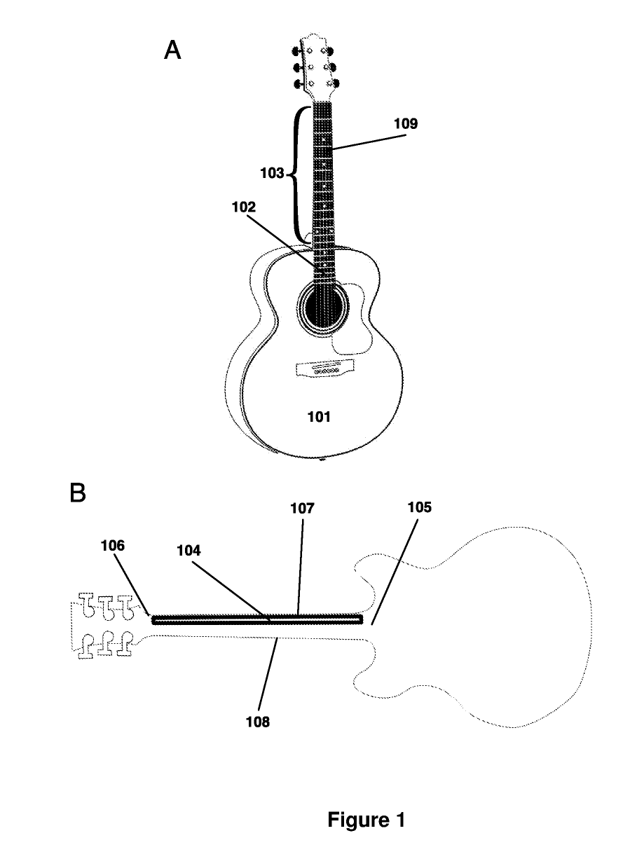

Reference is now made to FIG. 1.A, which shows an illustrative example of an augmented stringed instrument such as an augmented guitar, and FIG. 1.B, which shows the rear view of such augmented instrument. Such augmented stringed instrument may comprise a body (101); strings (102); a neck (103) having two longitudinal extremities (105) and (106), one extremity (105) secured to the body of the instrument; a longitudinally extending top side (107) and a longitudinally extending bottom side (108), such sides (107) and (108) located opposite to each other along the neck (103) of the instrument; the front part of the neck (103) named fingerboard (109).

A specific location (104) on the back of the neck (202) corresponding to the longitudinally extending top side (107) is the ideal bed for sensors thanks to a prompt accessibility by the player's thumb during the act of playing.

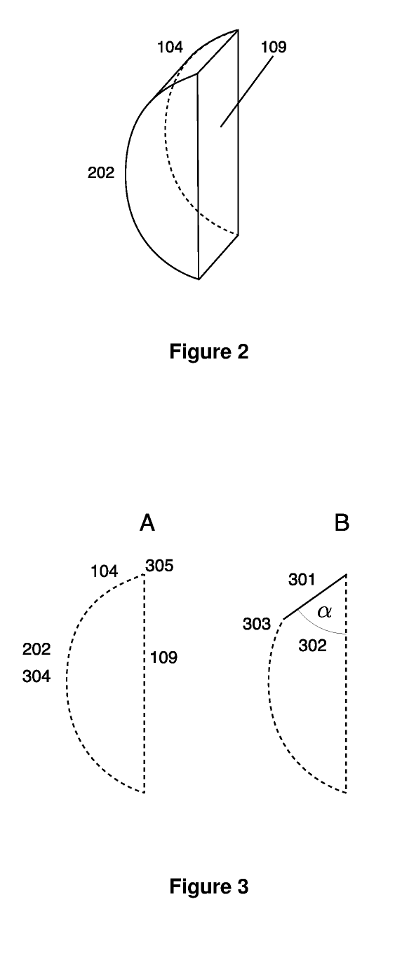

FIG. 2 shows a sectional view of the neck (103) of the instrument, such neck (103) comprising a front part, named fingerboard (109) and a back part (202).

The object of the present invention is represented in FIG. 3A and FIG. 3.B as a purposefully shaped design of the neck (103). Along the ideal bed (104) of the neck, a section is specifically grooved (301). Such design (FIG. 3.B) is particularly advantageous compared to the traditional half-rounded shape of the back of the neck (FIG. 3.A) because it allows a full pressure on the sensors on the flat surface (301). Sensors are located along the grooved surface (301) and, in a longitudinally extending perspective, alternatively along the full length of the neck (103) or simply on a portion of it.

The grooved flat surface (301) creates an angle α (302) with the top extremity (305) of the fingerboard, such angle α (302) ideally between 60 and 70 degrees.

The main advantages of this solution are:
1. Compared to any other possible placement (for instance, on the central part of the neck (304)), the specific placement (104) of the sensors minimizes accidental/unwanted activation/deactivation of the sensors by the thumb under the neck, therefore facilitating the access and control of the sensors without disrupting the natural interaction of the player with the instrument and in particular with its neck (103).
2. The edge (303) on the back of the neck (202) facilitates the recognition of the exact location of the sensors simply by the sense of touch, and therefore allowing the player to easily activate the sensors.
3. The ad-hoc grooved flat surface (104) acts as a “railway” to give better grip to the thumb on pressing and or manipulating the sensors.

The figures represented in this document provide just an illustrative example and do not limit the invention to only such representation.

While guitars have been used and described herein as examples for the application of the present invention, the proposed necks may also be used with other stringed instruments such as bass guitars, violins, cello, mandolins, and the like.

Moreover, while the guitars illustrated herein are guitars for right-handed players, the invention described herein may be applied to guitars, and other stringed instruments, intended for left-hand players. For example, a left-handed guitar may be constructed as a mirror image of one of the right-handed guitars illustrated herein.

### CITED REFERENCES

T. Machover and J. Chung. “Hyperinstruments: Musically intelligent and interactive performance and creativity systems.” (1989).
U.S. Pat. No. 8,093,486 B2
U.S. Pat. No. 7,718,886 B1
U.S. Pat. No. 7,247,789 B2
U.S. Pat. No. 6,570,078 B2

What is claimed is:

1. An augmented stringed instrument characterized by:
a. a neck (103) consisting of a bottom extremity (106) for receiving the body (101) of an augmented stringed instrument; a top extremity relative to the top extremity (105); a longitudinally extending top side (107) and a longitudinally extending bottom side (108); a front part of the neck named fingerboard (109);
b. the back of the neck (202) purposefully grooved to form a flat surface (301) located in correspondence to the longitudinally extending top side (107);
c. an edge (303) on the back of the neck (202) that can be perceived on fingertip touch;
d. a bed (104) for one or more sensors on the flat surface (301) of the back of the neck (202) located in correspondence to the longitudinally extending top side (107);

2. An augmented stringed instrument as in claim 1, wherein the grooved flat surface (301) creates an angle (302) of between 60 and 70 degrees with respect to the top extremity (305) of the fingerboard (109).
